(19) United States
(12) Patent Application Publication
(10) Pub. No.: US 2026/0356289 A1
(43) Pub. Date: Nov. 12, 2026

(54) SYSTEMS AND METHODS FOR MANAGING SIDE VIEW IMAGES IN A VEHICLE

(71) Applicant: GM GLOBAL TECHNOLOGY OPERATIONS LLC, Detroit, MI (US)

(72) Inventors: Seokju Yong, Bucheon-si (KR); Eungkyung Kim, Incheon (KR); Jongmin Park, Seocho-gu (KR); Gyu Jin Jung, Jung-gu (KR); Daniel Pinheiro Carlesimo, Rochester Hills, MI (US)

(73) Assignee: GM GLOBAL TECHNOLOGY OPERATIONS LLC, Detroit, MI (US)

(21) Appl. No.: 19/202,235

(22) Filed: May 8, 2025

(51) Int. Cl. B60R 1/23; B60R 1/04; B60R 1/12; G06V 20/59; G06V 40/18

(52) U.S. Cl. CPC B60R 1/23; B60R 1/04; B60R 1/12; G06V 20/593; G06V 20/597; G06V 40/18; B60R 2001/1215; B60R 2300/105; B60R 2300/303; B60R 2300/305

(57) ABSTRACT

Systems and methods for managing side view images in a vehicle are provided. A first side view image is received from a first side view camera of the vehicle. A rear view image is received from a rear view camera of the vehicle. A display image including at least a portion of the first side view image and at least a portion of the rear view image is generated for display on a display device of the vehicle.

The technical field generally relates to vehicles, and more particularly relates to systems and methods for managing side view images in a vehicle.

Mirror display devices of a vehicle typically include a left side view mirror display device, a right side view mirror display device, and a rear view mirror display device. The side view mirror display devices are configured to display side view images captured by side view cameras disposed on the sides of the vehicle. The rear view mirror display device is configured to display rear view images captured by a rear view camera disposed on a tailgate of the vehicle. The side view images include side views of the vehicle body.

Accordingly, it is desirable to provide systems and methods for managing vehicle mirror displays. Other desirable features and characteristics will become apparent from the subsequent detailed description and the appended claims, taken in conjunction with the accompanying drawings and the foregoing technical field and background.

### SUMMARY

A system for managing side view images in a vehicle includes at least one processor and at least one memory communicatively coupled to the at least one processor. The at least one memory includes instructions that upon execution by the at least one processor, causes the at least one processor to: receive a first side view image from a first side view camera of the vehicle; receive a rear view image from a rear view camera of the vehicle; and generate a display image including at least a portion of the first side view image and at least a portion of the rear view image for display on a display device of the vehicle.

In at least one embodiment, the at least one memory further includes instructions that upon execution by the at least one processor, causes the at least one processor to generate the display image by: transforming the at least the portion of the first side view image and the at least the portion of the rear view image into a first coordinate system using a homography algorithm; aligning the at least the portion of the first side view image with the at least the portion the rear view image using a stitching algorithm; and merging overlapping areas of the at least the portion of the first side view image and the at least the portion of the rear view image using a blending algorithm.

In at least one embodiment, the first side view image includes the at least the portion of the side view image and an image area including a side view of a vehicle body of the vehicle; and the at least one memory further includes instructions that upon execution by the at least one processor, causes the at least one processor to replace the image area of the first side view image with the at least the portion of the rear view image to generate the display image for display on the display device, wherein the at least the portion of the rear view image corresponds to the image area.

In at least one embodiment, the display device is a side view mirror display device.

In at least one embodiment, the at least one memory further includes instructions that upon execution by the at least one processor, causes the at least one processor to generate the display image to include a delineation line separating the at least the portion of the side view image from the at least the portion of the rear view image.

In at least one embodiment, the at least one memory further includes instructions that upon execution by the at least one processor, causes the at least one processor to: upon detection of a left turn signal activation, receive the first side view image from the first side view camera of the vehicle, wherein the first side view image includes a left side view image and the first side view camera includes a left side view camera of the vehicle; upon detection of a right turn signal activation, receive the first side view image from the first side view camera of the vehicle, wherein the first side view image includes a right side view image and the first side view camera includes a right side view camera of the vehicle; and generate the display image for display on the display device, wherein the display device is a center console display device.

In at least one embodiment, the at least one memory further includes instructions that upon execution by the at least one processor, causes the at least one processor to: receive a left side view mirror display image; receive a right side view mirror display image; and generate the display image to include the left side view mirror display image, the rear view image, and the right side view mirror display image for display on the display device, wherein the display device is a rear view mirror display device.

In at least one embodiment, the at least one memory further includes instructions that upon execution by the at least one processor, causes the at least one processor to generate the display image by: transforming the left side view mirror display image, the rear view image, and the right side view mirror display image into a second coordinate system using a homography algorithm; aligning the left side view mirror display image, the rear view image, and the right side view mirror display image using a stitching algorithm; and merging overlapping areas of the left side view mirror display image, the rear view image, and the right side view mirror display image using a blending algorithm.

In at least one embodiment, the at least one memory further includes instructions that upon execution by the at least one processor, causes the at least one processor to generate the display image for display on the rear view mirror display device to include a first pop-up of the left side view mirror display image, the rear view image, and a second pop-up of the right side view mirror display image, wherein the first pop-up and the second pop-up overlay the rear view image.

In at least one embodiment, the at least one memory further includes instructions that upon execution by the at least one processor, causes the at least one processor to receive a driver line of sight from a driver monitoring system; receive a passenger position of a passenger in a front seat of the vehicle from the driver monitoring system; determine whether the driver line of sight is in a direction towards a right side view mirror display device of the vehicle and the passenger position is along the driver line of sight; and generate the display image to include the left side view mirror display image, the rear view image, and the right side view mirror display image for display on the display device, wherein the display device is a rear view mirror display device based on the determination.

In at least one embodiment, the at least one memory further includes instructions that upon execution by the at least one processor, causes the at least one processor to: detect a malfunction of one of a right side view mirror display device and a left side view mirror display device of the vehicle; and generate the display image to include the left side view mirror display image, the rear view image, and the right side view mirror display image for display on the display device, wherein the display device is a rear view mirror display device.

In at least one embodiment, the at least one memory further includes instructions that upon execution by the at least one processor, causes the at least one processor to: issue a command to reboot the one of the right side view mirror display device and the left side view mirror display device; determine whether the reboot the one of the right side view mirror display device and the left side view mirror display device resolved the malfunction; and generate a malfunction notification for display on a central console display of the vehicle based on the determination.

A method of managing side view images in a vehicle includes: receiving a first side view image from a first side view camera of the vehicle; receiving a rear view image from a rear view camera of the vehicle; and generating a display image including at least a portion of the first side view image and at least a portion of the rear view image for display on a display device of the vehicle.

In at least one embodiment, the first side view image includes the at least the portion of the side view image and an image area including a side view of a vehicle body of the vehicle; and the method further includes replacing the image area of the first side view image with the at least the portion of the rear view image to generate the display image for display on the display device, wherein the at least the portion of the rear view image corresponds to the image area.

In at least one embodiment, the display device is a side view mirror display device.

In at least one embodiment, the method further includes generating the display image to include a delineation line separating the at least the portion of the side view image from the at least the portion of the rear view image.

In at least one embodiment, the method further includes: upon detection of a left turn signal activation, receiving the first side view image from the first side view camera of the vehicle, wherein the first side view image includes a left side view image and the first side view camera includes a left side view camera of the vehicle; upon detection of a right turn signal activation, receiving the first side view image from the first side view camera of the vehicle, wherein the first side view image includes a right side view image and the first side view camera includes a right side view camera of the vehicle; and generating the display image for display on the display device, wherein the display device is a center console display device.

In at least one embodiment, the method further includes: receiving a left side view mirror display image; receiving a right side view mirror display image; and generating the display image to include the left side view mirror display image, the rear view image, and the right side view mirror display image for display on the display device, wherein the display device is a rear view mirror display device.

In at least one embodiment, the method further includes: receiving a driver line of sight from a driver monitoring system; receiving a passenger position of a passenger in a front seat of the vehicle from the driver monitoring system; determining whether the driver line of sight is in a direction towards a right side view mirror display device of the vehicle and the passenger position is along the driver line of sight; and generating the display image to include the left side view mirror display image, the rear view image, and the right side view mirror display image for display on the display device, wherein the display device is a rear view mirror display device based on the determination.

A vehicle including a system for managing side view images in the vehicle includes at least one processor and at least one memory communicatively coupled to the at least one processor. The at least one memory includes instructions that upon execution by the at least one processor, causes the at least one processor to: receive a side view image from a side view camera of the vehicle, wherein the side view image includes an image area including a side view of a vehicle body of the vehicle; receive a rear view image from a rear view camera of the vehicle; and generate a display image for display on a side view mirror display device by: replacing the image area of the side view image with at least a portion of the rear view image, wherein the at least the portion of the rear view image corresponds to the image area of the side view image; and generating a delineation line separating the image area including the at least the portion of the rear view image from a remaining portion of the side view image.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle including a side view image management system in accordance with at least one embodiment;

FIG. 2 is a functional block diagram of a controller including a side view image management system in accordance with at least one embodiment;

FIG. 3 is a flowchart representation of an exemplary method of managing side view images to generate a display image for display on a side view mirror display device of a vehicle in accordance with at least one embodiment;

FIG. 4 is an exemplary illustration of a left side view mirror display image displayed on a left side view mirror display device in accordance with at least one embodiment;

FIG. 5 is a flowchart representation of an exemplary method of managing side view images to generate a display image for display on a rear view mirror display device in accordance with at least one embodiment;

FIG. 6 is an exemplary illustration of a rear view mirror display image displayed on a rear view mirror display device in accordance with at least one embodiment; and

FIG. 7 is an exemplary illustration of a rear view mirror display image including pop-ups of a left side view image and a right side view image displayed on a rear view mirror display device in accordance with at least one embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

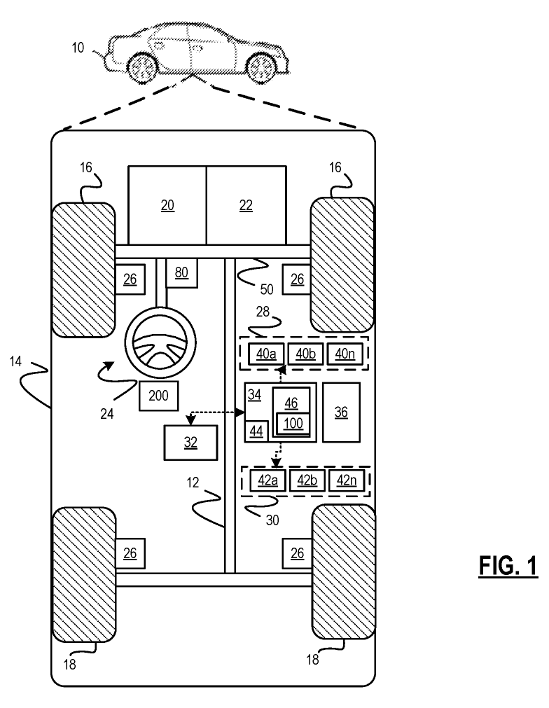

Referring to FIG. 1, a functional block diagram of a vehicle including a side view image management system 100 in accordance with at least one embodiment is shown. The vehicle 10 generally includes a chassis 12, a body 14, front wheels 16, and rear wheels 18. While the vehicle 10 is depicted in the illustrated embodiment as a passenger car, the vehicle 10 may be other types of vehicles including trucks, sport utility vehicles (SUVs), and recreational vehicles (RVs).

In various embodiments, the body 14 is arranged on the chassis 12 and substantially encloses components of the vehicle 10. The body 14 and the chassis 12 may jointly form a frame. The wheels 16, 18 are each rotationally coupled to the chassis 12 near a respective corner of the body 14.

In various embodiments, the vehicle 10 is an autonomous or semi-autonomous vehicle that is automatically controlled to carry passengers and/or cargo from one place to another. For example, in an exemplary embodiment, the vehicle 10 is a so-called Level Two, Level Three, Level Four or Level Five automation system. Level two automation means the vehicle assists the driver in various driving tasks with driver supervision. Level three automation means the vehicle can take over all driving functions under certain circumstances. All major functions are automated, including braking, steering, and acceleration. At this level, the driver can fully disengage until the vehicle tells the driver otherwise. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the vehicle 10 generally includes a propulsion system 20 a transmission system 22, a steering system 24, a braking system 26, a sensor system 28, an actuator system 30, at least one data storage device 32, at least one controller 34, and a communication system 36. The controller 34 is configured to implement an automated driving system (ADS). The propulsion system 20 is configured to generate power to propel the vehicle. The propulsion system 20 includes an internal combustion engine (ICE). The propulsion system 20 may, in various embodiments, also include an electric machine such as a traction motor, a fuel cell propulsion system, and/or any other type of propulsion configuration. The transmission system 22 is configured to transmit power from the propulsion system 20 to the vehicle wheels 16, 18 according to selectable speed ratios. According to various embodiments, the transmission system 22 may include a step-ratio automatic transmission, a continuously-variable transmission, or other appropriate transmission. The braking system 26 is configured to provide braking torque to the vehicle wheels 16, 18. The braking system 26 may, in various embodiments, include friction brakes, brake by wire, a regenerative braking system such as an electric machine, and/or other appropriate braking systems.

The steering system 24 is configured to influence a position of the of the vehicle wheels 16. While depicted as including a steering wheel and steering column, for illustrative purposes, in some embodiments contemplated within the scope of the present disclosure, the steering system 24 may not include a steering wheel and/or steering column. The steering system 24 includes a steering column coupled to an axle 50 associated with the front wheels 16 through, for example, a rack and pinion or other mechanism (not shown). Alternatively, the steering system 24 may include a steer by wire system that includes actuators associated with each of the front wheels 16.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, a steering wheel sensor, and/or other sensors.

The vehicle dynamics sensors provide vehicle dynamics data including longitudinal speed, yaw rate, lateral acceleration, longitudinal acceleration, etc. The vehicle dynamics sensors may include wheel sensors that measure information pertaining to one or more wheels of the vehicle 10. In one embodiment, the wheel sensors comprise wheel speed sensors that are coupled to each of the wheels 16, 18 of the vehicle 10. Further, the vehicle dynamics sensors may include one or more accelerometers (provided as part of an Inertial Measurement Unit (IMU)) that measure information pertaining to an acceleration of the vehicle 10. In various embodiments, the accelerometers measure one or more acceleration values for the vehicle 10, including latitudinal and longitudinal acceleration and yaw rate. In at least one embodiment, the vehicle dynamic sensors provide vehicle location and vehicle movement data.

The actuator system 30 includes one or more actuator devices 42a-42n that control one or more vehicle features such as, but not limited to, one or more vehicle wheels 16, 18 the propulsion system 20, the transmission system 22, the steering system 24, and the braking system 26. In various embodiments, the vehicle features can further include interior and/or exterior vehicle features such as, but are not limited to, doors, a trunk, and cabin features such as air, music, lighting, etc. (not numbered).

The communication system 36 is configured to wirelessly communicate information to and from other entities 48, such as but not limited to, other vehicles (vehicle to vehicle, “V2V” communication,) infrastructure (vehicle to infrastructure “V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in the ADS of the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10. In at least one embodiment, the computer-readable storage device 46 is at least one memory configured to store the side view image management system 100.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10. In various embodiments, the controller(s) 34 are configured to implement ADS.

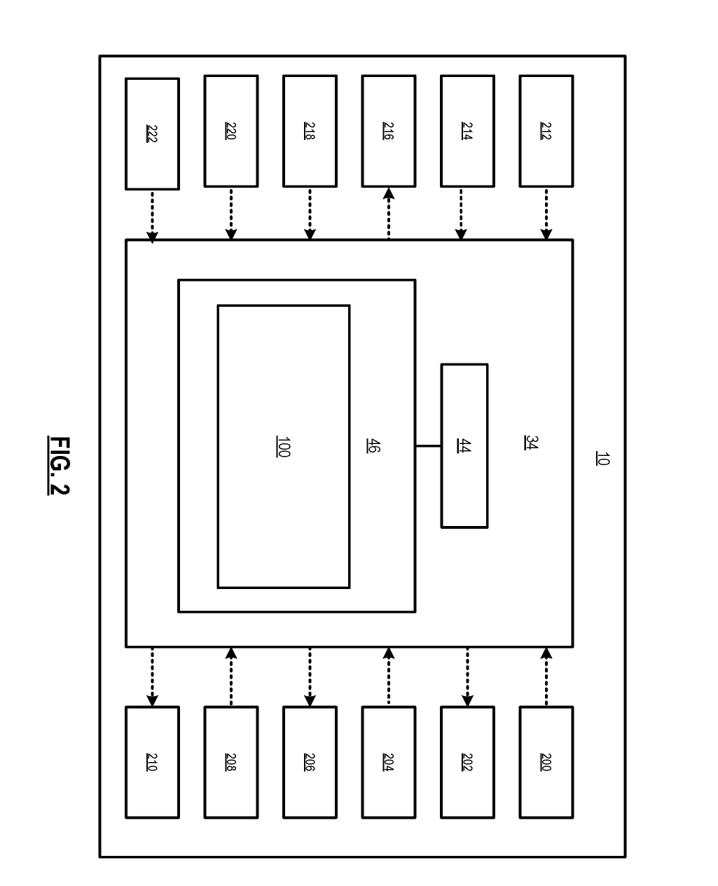

Referring to FIG. 2, a functional block diagram of a controller 34 including a side view image management system 100 in accordance with at least one embodiment is shown. The controller 34 includes at least one processor 44 and at least one memory 46. The at least one processor 44 is a programable device that includes one or more instructions stored in or associated with the at least one memory 46. The at least one memory 46 includes instructions that the at least one processor 44 is configured to execute. The at least one memory 46 includes an embodiment of the side view image management system 100.

The controller 34 is configured to be communicatively coupled to a left side view camera 200, a left side view mirror display device 202, a right side view camera 204, a right side view mirror display device 206, a rear view camera 208, a rear view mirror display device 210, a left turn signal 212, a right turn signal 214, a center console display 216, a display diagnostics system 218, a driver monitoring system 220 and a user input device 222. In at least one embodiment, the controller 34 may be referred to as the side view image management system 100. The operation of the side view image management system 100 will be described in greater detail below.

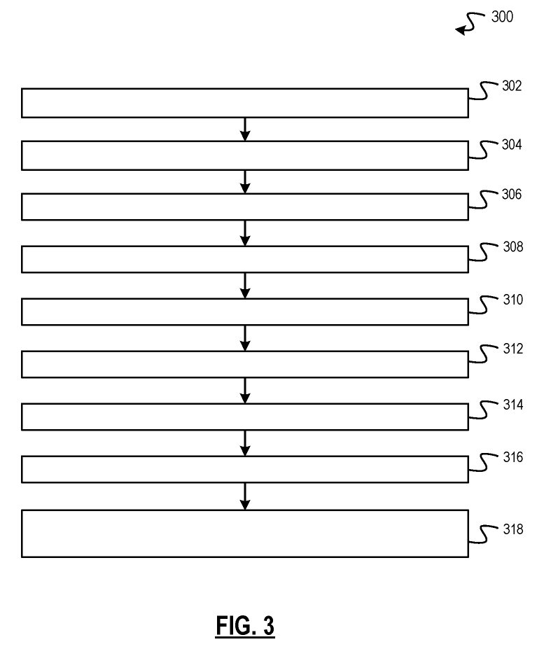

Referring to FIG. 3, a flowchart representation of an exemplary method 300 of managing side view images to generate a display image for display on a side view mirror display device 202, 206 of a vehicle 10 in accordance with at least one embodiment is shown. The method 300 will be described with reference to an exemplary implementation of an embodiment of a side view image management system 100. As can be appreciated in light of the disclosure, the order of operation within the method 300 is not limited to the sequential execution as illustrated in FIG. 3 but may be performed in one or more varying orders as applicable and in accordance with the present disclosure.

At 302, the side view image management system 100 is activated. In at least one embodiment, a driver of the vehicle 10 is provided with an option of activating operation of the side view image management system 100. The side view image management system 100 is activated in response to receiving a driver selection to activate the operation of the side view image management system 100 via a user input device 222.

At 304, the side view image management system 100 receives a left side view image from a left side view camera 200 and a right side view image from a right side view camera 204. The left side view image captured by the left side view camera 200 includes a left side view of a vehicle body of the vehicle 10. The presence of the left side view of the vehicle body of the vehicle 10 in the range of the left side view camera 200 creates a blind spot area in the left side view image. The right side view image captured by the right side view camera 204 includes a right side view of the vehicle body of the vehicle 10. The presence of the right side view of the vehicle body of the vehicle 10 in the range of the right side view camera 204 creates a blind spot area in the right side view image.

At 306, the side view image management system 100 receives a rear view image captured by a rear view camera 208. In at least one embodiment, the rear view camera 208 is disposed on a tailgate of the vehicle 10. The rear view image captured by the rear view camera 208 includes coverage of the blind spot area in left side view image captured by the left side view camera 200 and the blind spot area in the right side view image captured by the right side view camera 204.

At 308, the side view image management system 100 identifies the blind spot area in the left side view image and the blind spot area in the right side view image. At 310, the side view image management system 100 extracts the portion of the left side view image that does not include the blind spot area and the portion of the right side view image that does not include the blind spot area. At 312, the side view image management system 100 extracts a first portion of the rear view image that corresponds to the blind spot area in the left side view image and a second portion of the rear view image that corresponds to the blind spot area in the right side view image.

At 314, the side view image management system 100 generates a left side view mirror display image and a right side view mirror display image. The side view image management system 100 replaces the blind spot area in the left side view image with the extracted first portion the rear view image that corresponds to the blind spot area in the left side view image to generate the left side view mirror display image. The side view image management system 100 replaces the blind spot area in the right side view image with the extracted second portion the rear view image that corresponds to the blind spot area in the right side view image to generate the right side view mirror display image.

The side view image management system 100 transforms the portion of the left side view image that does not include the blind spot area and the first portion the rear view image that corresponds to the blind spot area in the left side view image into a coordinate system using a homography algorithm. The side view image management system 100 then aligns the portion of the left side view image that does not include the blind spot area with the first portion the rear view image that corresponds to the blind spot area in the left side view image using a stitching algorithm. The side view image management system 100 then merges overlapping areas of the portion of the left side view image that does not include the blind spot area with the first portion the rear view image that corresponds to the blind spot area in the left side view image using a blending algorithm to generate the left side view mirror display image.

The side view image management system 100 transforms the portion of the right side view image that does not include the blind spot area and the second portion the rear view image that corresponds to the blind spot area in the right side view image into a coordinate system using a homography algorithm. The side view image management system 100 then aligns the portion of the right side view image that does not include the blind spot area with the second portion the rear view image that corresponds to the blind spot area in the right side view image using a stitching algorithm. The side view image management system 100 then merges overlapping areas of the portion of the right side view image that does not include the blind spot area with the second portion the rear view image that corresponds to the blind spot area in the right side view image using a blending algorithm to generate the right side view mirror display image.

At 316, the side view image management system 100 generates a first delineation line separating the portion of the left side view image that does not include the blind spot area from the first portion the rear view image that corresponds to the blind spot area in the left side view image for inclusion in the left side view mirror display image and a second delineation line that separates the portion of the right side view image that does not include the blind spot area and the second portion the rear view image that corresponds to the blind spot area in the right side view image for inclusion in the right side view mirror display image.

At 318, the side view image management system 100 transmits the left side view mirror display image to the left side view mirror display device 202 and the right side view mirror display image to the right side view mirror display device 206. The left side view mirror display device 202 receives and displays the left side view mirror display image. The right side view mirror display device 206 receives and displays the right side view mirror display image.

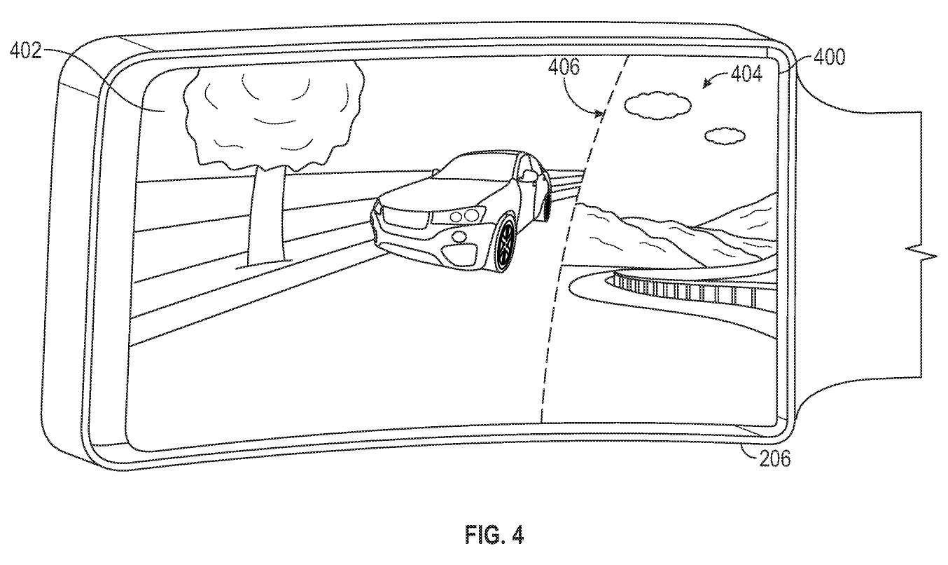

Referring to FIG. 4, an exemplary illustration of a left side view mirror display image 400 displayed on a left side view mirror display device 202 in accordance with at least one embodiment is shown. The left side view mirror display image 400 includes a portion of the left side view image that does not include the blind spot area 402, a portion of the rear view image that corresponds to the blind spot area, and a delineation line 406 separating the portion of the left side view image that does not include the blind spot area 402 from the portion the rear view image that corresponds to the blind spot area 404.

In at least one embodiment, the side view image management system 100 is activated in response to detecting activation of a left turn signal 212 of the vehicle 10. The side view image management system 100 receives a left side view image from a left side view camera 200. The left side view image captured by the left side view camera 200 includes a left side view of the vehicle body of the vehicle 10. The presence of the left side view of the vehicle body of the vehicle 10 in the range of the left side view camera 200 creates a blind spot area in the left side view image.

The side view image management system 100 receives a rear view image captured by a rear view camera 208. The rear view image captured by the rear view camera 208 includes coverage of the blind spot area in left side view image captured by the left side view camera 200. The side view image management system 100 identifies the blind spot area in the left side view image, extracts the portion of the left side view image that does not include the blind spot area and extracts a portion of the rear view image that corresponds to the blind spot area in the left side view image.

The side view image management system 100 generate a left side view mirror display image. The side view image management system 100 replaces the blind spot area in the left side view image with the extracted portion the rear view image that corresponds to the blind spot area in the left side view image to generate the left side view mirror display image. The side view image management system 100 transmits the left side view mirror display image to a center console display 216. The center console display 216 receives and displays the left side view mirror display image.

In at least one embodiment, the side view image management system 100 is activated in response to detecting activation of a right turn signal 214 of the vehicle 10. The side view image management system 100 receives a right side view image from a right side view camera 204. The right side view image captured by the right side view camera 204 includes a right side view of the vehicle body of the vehicle 10. The presence of the right side view of the vehicle body of the vehicle 10 in the range of the right side view camera 204 creates a blind spot area in the right side view image.

The side view image management system 100 receives a rear view image captured by a rear view camera 208. The rear view image captured by the rear view camera 208 includes coverage of the blind spot area in right side view image captured by the right side view camera 204. The side view image management system 100 identifies the blind spot area in the right side view image, extracts the portion of the right side view image that does not include the blind spot area and extracts a portion of the rear view image that corresponds to the blind spot area in the right side view image.

The side view image management system 100 generate a right side view mirror display image. The side view image management system 100 replaces the blind spot area in the right side view image with the extracted portion the rear view image that corresponds to the blind spot area in the right side view image to generate the right side view mirror display image. The side view image management system 100 transmits the right side view mirror display image to a center console display 216. The center console display 216 receives and displays the right side view mirror display image.

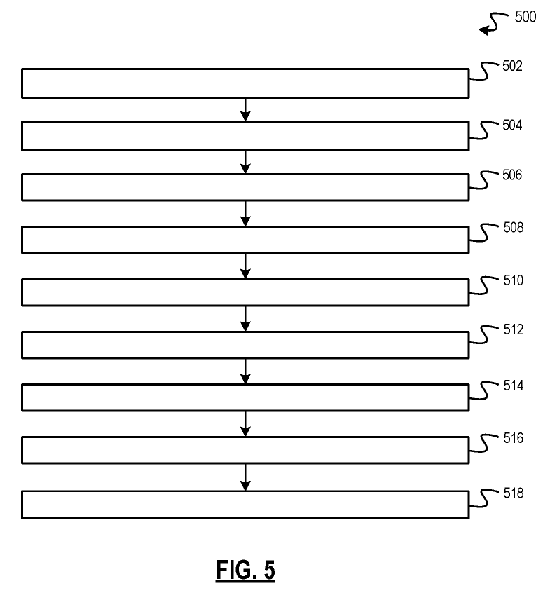

Referring to FIG. 5, a flowchart representation of an exemplary method 500 of managing side view images to generate a display image for display on a rear view mirror display device 210 on a vehicle 10 in accordance with at least one embodiment is shown. The method 500 will be described with reference to an exemplary implementation of an embodiment of a side view image management system 100. As can be appreciated in light of the disclosure, the order of operation within the method 500 is not limited to the sequential execution as illustrated in FIG. 5 but may be performed in one or more varying orders as applicable and in accordance with the present disclosure.

At 502, the side view image management system 100 is activated. In at least one embodiment, a driver of the vehicle 10 is provided with an option of activating operation of the side view image management system 100. The side view image management system 100 is activated in response to receiving a driver selection to activate the operation of the side view image management system 100 via a user input device 222.

In at least one embodiment, the side view image management system 100 receive a driver line of sight and a passenger position of a passenger in a front seat of the vehicle 10 from a driver monitoring system 220 of the vehicle 10. The side view image management system 100 determines whether the driver line of sight is in a direction towards a right side view mirror display device 206 of the vehicle 10 and the passenger position is along the driver line of sight such that the passenger is disposed between the driver of the vehicle 10 and the right side view mirror display device 206 effectively blocking the driver’s view of the right side view mirror display device 206. The side view image management system 100 is activated in response to a determination that the driver line of sight is in a direction towards a right side view mirror display device 206 of the vehicle 10 and the passenger position is along the driver line of sight.

In at least one embodiment, when the vehicle ignition is turned on in the vehicle 10, a display diagnostics system 218 of the vehicle 10 performs diagnostics on the left side view mirror display device 202 and the right side view mirror display device 206. If a malfunction of at least one of the left side view mirror display device 202 and the right side view mirror display device 206 is detected, the side view image management system 100 is activated.

In at least one embodiment, if a malfunction of one of the left side view mirror display device 202 and the right side view mirror display device 206 is detected, a reboot command is issued to reboot the one of the left side view mirror display device 202 and the right side view mirror display device 206 with the detected malfunction. The one of the left side view mirror display device 202 and the right side view mirror display device 206 with the detected malfunction performs a reboot in response to the received reboot command.

A determination is made by the display diagnostics system 218 regarding whether the reboot of the one of the left side view mirror display device 202 and the right side view mirror display device 206 with the detected malfunction resolved the malfunction. If the display diagnostics system 218 determines that the reboot of the one of the left side view mirror display device 202 and the right side view mirror display device 206 did not resolve the malfunction, the side view image management system 100 is activated. The side view image management system 100 generates a malfunction notification to “visit a dealer shop” for display on the center console display 216.

At 504, the side view image management system 100 receives a left side view image from a left side view camera 200 and a right side view image from a right side view camera 204. The left side view image captured by the left side view camera 200 includes a left side view of the vehicle body of the vehicle 10. The presence of the left side view of a vehicle body of the vehicle 10 in the range of the left side view camera 200 creates a blind spot area in the left side view image. The right side view image captured by the right side view camera 204 includes a right side view of the vehicle body of the vehicle 10. The presence of the right side view of the vehicle body of the vehicle 10 in the range of the right side view camera 204 creates a blind spot area in the right side view image.

At 506, the side view image management system 100 receives a rear view image captured by a rear view camera 208. In at least one embodiment, the rear view camera 208 is disposed on a tailgate of the vehicle 10. The rear view image captured by the rear view camera 208 includes coverage of the blind spot area in left side view image captured by the left side view camera 200 and the blind spot area in the right side view image captured by the right side view camera 204.

At 508, the side view image management system 100 identifies the blind spot area in the left side view image and the blind spot area in the right side view image. At 510, the side view image management system 100 extracts the portion of the left side view image that does not include the blind spot area and the portion of the right side view image that does not include the blind spot area. At 512, the side view image management system 100 extracts a first portion of the rear view image that corresponds to the blind spot area in the left side view image and a second portion of the rear view image that corresponds to the blind spot area in the right side view image.

At 514, the side view image management system 100 generate a left side view mirror display image and a right side view mirror display image. The side view image management system 100 replaces the blind spot area in the left side view image with the extracted first portion the rear view image that corresponds to the blind spot area in the left side view image to generate the left side view mirror display image. The side view image management system 100 replaces the blind spot area in the right side view image with the extracted second portion the rear view image that corresponds to the blind spot area in the right side view image to generate the right side view mirror display image.

The side view image management system 100 transforms the portion of the left side view image that does not include the blind spot area and the first portion the rear view image that corresponds to the blind spot area in the left side view image into a coordinate system using a homography algorithm. The side view image management system 100 then aligns the portion of the left side view image that does not include the blind spot area with the first portion the rear view image that corresponds to the blind spot area in the left side view image using a stitching algorithm. The side view image management system 100 then merges overlapping areas of the portion of the left side view image that does not include the blind spot area with the first portion the rear view image that corresponds to the blind spot area in the left side view image using a blending algorithm to generate the left side view mirror display image.

The side view image management system 100 transforms the portion of the right side view image that does not include the blind spot area and the second portion the rear view image that corresponds to the blind spot area in the right side view image into a coordinate system using a homography algorithm. The side view image management system 100 then aligns the portion of the right side view image that does not include the blind spot area with the second portion the rear view image that corresponds to the blind spot area in the right side view image using a stitching algorithm. The side view image management system 100 then merges overlapping areas of the portion of the right side view image that does not include the blind spot area with the second portion the rear view image that corresponds to the blind spot area in the right side view image using a blending algorithm to generate the right side view mirror display image.

At 516, the side view image management system 100 generates a rear view mirror display image. In at least one embodiment, the side view image management system 100 transforms the left side view mirror display image, the rear view image, and the right side view mirror display image into a coordinate system using a homography algorithm. The side view image management system 100 then aligns the left side view mirror display image, the rear view image, and the right side view mirror display image using a stitching algorithm. The side view image management system 100 then merges overlapping areas of the left side view mirror display image, the rear view image, and the right side view mirror display image using a blending algorithm to generate the rear view mirror display image. The rear view mirror display image is a seamless panoramic view generated by the combination of the left side view mirror display image, the rear view image, and the right side view mirror display image.

In at least one embodiment, the side view image management system 100 generates a first pop-up of the left side view mirror display image and a second pop-up of the right side view mirror display image. The side view image management system 100 overlays the first pop-up of the left side view mirror display image on a far left side of the rear view image and the second pop-up of the right side view mirror display image on a far right side of the rear view image display to generate the rear view mirror display image.

At 518, the side view image management system 100 transmits the rear view mirror display image to a rear view mirror display device 210 of the vehicle 10. The rear view mirror display device 210 receives and displays the rear view mirror display image.

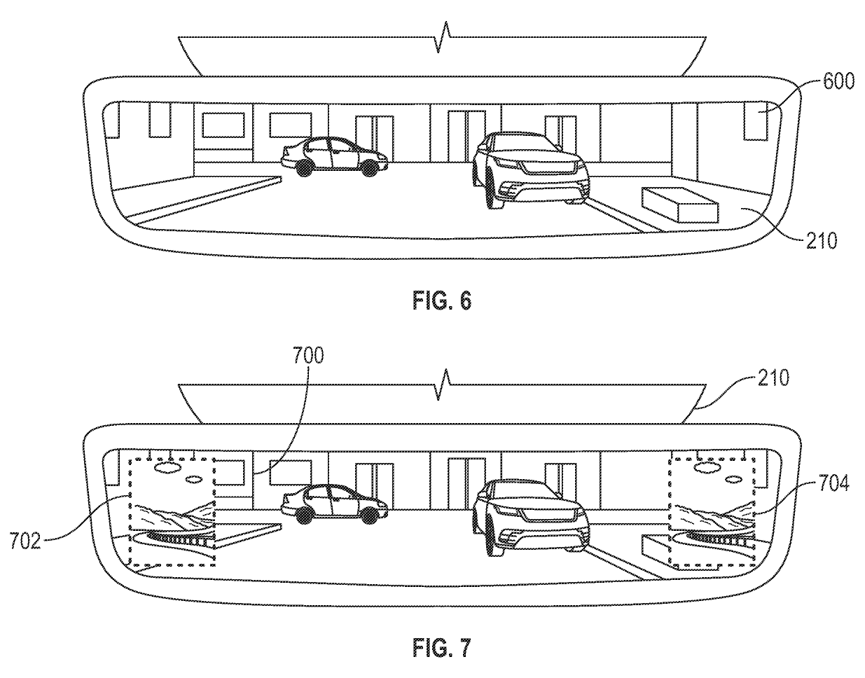

Referring to FIG. 6, an exemplary illustration of a rear view mirror display image 600 displayed on a rear view mirror display device 210 in accordance with at least one embodiment is shown. The rear view mirror display image 600 is a seamless panoramic view generated by the combination of the left side view mirror display image, the rear view image, and the right side view mirror display image.

Referring to FIG. 7, an exemplary illustration of a rear view mirror display image 700 including a pop-up of a left side view image 702 and a pop-up of a right side view image 704 displayed on a rear view mirror display device 210 in accordance with at least one embodiment is shown. The first pop-up of the left side view mirror display image 702 is disposed on a far left side of the rear view image and the second pop-up of the right side view mirror display image 704 is disposed on a far right side of the rear view image display to generate the rear view mirror display image 700. The first pop-up of the left side view mirror display image 702 and the second pop-up of the right side view mirror display image 704 are overlayed on the rear view image.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system for managing side view images in a vehicle, comprising:
at least one processor; and
at least one memory communicatively coupled to the at least one processor, the at least one memory comprising instructions that upon execution by the at least one processor, causes the at least one processor to:
receive a first side view image from a first side view camera of the vehicle;
receive a rear view image from a rear view camera of the vehicle; and
generate a display image comprising at least a portion of the first side view image and at least a portion of the rear view image for display on a display device of the vehicle.

2. The system of claim 1, wherein the at least one memory further comprises instructions that upon execution by the at least one processor, causes the at least one processor to generate the display image by:
transforming the at least the portion of the first side view image and the at least the portion of the rear view image into a first coordinate system using a homography algorithm;
aligning the at least the portion of the first side view image with the at least the portion the rear view image using a stitching algorithm; and
merging overlapping areas of the at least the portion of the first side view image and the at least the portion of the rear view image using a blending algorithm.

3. The system of claim 1, wherein:
the first side view image comprises the at least the portion of the side view image and an image area comprising a side view of a vehicle body of the vehicle; and
the at least one memory further comprises instructions that upon execution by the at least one processor, causes the at least one processor to replace the image area of the first side view image with the at least the portion of the rear view image to generate the display image for display on the display device, wherein the at least the portion of the rear view image corresponds to the image area.

4. The system of claim 3, wherein the display device comprises a side view mirror display device.

5. The system of claim 4, the at least one memory further comprises instructions that upon execution by the at least one processor, causes the at least one processor to generate the display image to include a delineation line separating the at least the portion of the side view image from the at least the portion of the rear view image.

6. The system of claim 3, the at least one memory further comprises instructions that upon execution by the at least one processor, causes the at least one processor to:
upon detection of a left turn signal activation, receive the first side view image from the first side view camera of the vehicle, wherein the first side view image comprises a left side view image and the first side view camera comprises a left side view camera of the vehicle;
upon detection of a right turn signal activation, receive the first side view image from the first side view camera of the vehicle, wherein the first side view image comprises a right side view image and the first side view camera comprises a right side view camera of the vehicle; and
generate the display image for display on the display device, wherein the display device is a center console display device.

7. The system of claim 1, the at least one memory further comprises instructions that upon execution by the at least one processor, causes the at least one processor to:
receive a left side view mirror display image;
receive a right side view mirror display image; and
generate the display image to include the left side view mirror display image, the rear view image, and the right side view mirror display image for display on the display device, wherein the display device is a rear view mirror display device.

8. The system of claim 7, wherein the at least one memory further comprises instructions that upon execution by the at least one processor, causes the at least one processor to generate the display image by:
transforming the left side view mirror display image, the rear view image, and the right side view mirror display image into a second coordinate system using a homography algorithm;
aligning the left side view mirror display image, the rear view image, and the right side view mirror display image using a stitching algorithm; and
merging overlapping areas of the left side view mirror display image, the rear view image, and the right side view mirror display image using a blending algorithm.

9. The system of claim 7, wherein the at least one memory further comprises instructions that upon execution by the at least one processor, causes the at least one processor to generate the display image for display on the rear view mirror display device to include a first pop-up of the left side view mirror display image, the rear view image, and a second pop-up of the right side view mirror display image, wherein the first pop-up and the second pop-up overlay the rear view image.

10. The system of claim 7, wherein the at least one memory further comprises instructions that upon execution by the at least one processor, causes the at least one processor to
receive a driver line of sight from a driver monitoring system;
receive a passenger position of a passenger in a front seat of the vehicle from the driver monitoring system;
determine whether the driver line of sight is in a direction towards a right side view mirror display device of the vehicle and the passenger position is along the driver line of sight; and
generate the display image to include the left side view mirror display image, the rear view image, and the right side view mirror display image for display on the display device, wherein the display device is a rear view mirror display device based on the determination.

11. The system of claim 7, wherein the at least one memory further comprises instructions that upon execution by the at least one processor, causes the at least one processor to:
detect a malfunction of one of a right side view mirror display device and a left side view mirror display device of the vehicle; and
generate the display image to include the left side view mirror display image, the rear view image, and the right side view mirror display image for display on the display device, wherein the display device is a rear view mirror display device.
.

12. The system of claim 11, wherein the at least one memory further comprises instructions that upon execution by the at least one processor, causes the at least one processor to:
issue a command to reboot the one of the right side view mirror display device and the left side view mirror display device;
determine whether the reboot the one of the right side view mirror display device and the left side view mirror display device resolved the malfunction; and
generate a malfunction notification for display on a central console display of the vehicle based on the determination.

13. A method of managing side view images in a vehicle comprising:
receiving a first side view image from a first side view camera of the vehicle;
receiving a rear view image from a rear view camera of the vehicle; and
generating a display image comprising at least a portion of the first side view image and at least a portion of the rear view image for display on a display device of the vehicle.

14. The method of claim 13, wherein:
the first side view image comprises the at least the portion of the side view image and an image area comprising a side view of a vehicle body of the vehicle; and
the method further comprises replacing the image area of the first side view image with the at least the portion of the rear view image to generate the display image for display on the display device, wherein the at least the portion of the rear view image corresponds to the image area.

15. The method of claim 14, wherein the display device comprises a side view mirror display device.

16. The method of claim 15, further comprising generating the display image to include a delineation line separating the at least the portion of the side view image from the at least the portion of the rear view image.

17. The method of claim 14, further comprising:
upon detection of a left turn signal activation, receiving the first side view image from the first side view camera of the vehicle, wherein the first side view image comprises a left side view image and the first side view camera comprises a left side view camera of the vehicle;
upon detection of a right turn signal activation, receiving the first side view image from the first side view camera of the vehicle, wherein the first side view image comprises a right side view image and the first side view camera comprises a right side view camera of the vehicle; and
generating the display image for display on the display device, wherein the display device is a center console display device.

18. The method of claim 13, further comprising:
receiving a left side view mirror display image;
receiving a right side view mirror display image; and
generating the display image to include the left side view mirror display image, the rear view image, and the right side view mirror display image for display on the display device, wherein the display device is a rear view mirror display device.

19. The method of claim 18, further comprising
receiving a driver line of sight from a driver monitoring system;
receiving a passenger position of a passenger in a front seat of the vehicle from the driver monitoring system;
determining whether the driver line of sight is in a direction towards a right side view mirror display device of the vehicle and the passenger position is along the driver line of sight; and
generating the display image to include the left side view mirror display image, the rear view image, and the right side view mirror display image for display on the display device, wherein the display device is a rear view mirror display device based on the determination.

20. A vehicle including a system for managing side view images in the vehicle comprising:
at least one processor; and
at least one memory communicatively coupled to the at least one processor, the at least one memory comprising instructions that upon execution by the at least one processor, causes the at least one processor to:
receive a side view image from a side view camera of the vehicle, wherein the side view image comprises an image area comprising a side view of a vehicle body of the vehicle;
receive a rear view image from a rear view camera of the vehicle; and
generate a display image for display on a side view mirror display device by:
replacing the image area of the side view image with at least a portion of the rear view image, wherein the at least the portion of the rear view image corresponds to the image area of the side view image; and
generating a delineation line separating the image area including the at least the portion of the rear view image from a remaining portion of the side view image.
